(19) United States
(12) Patent Application Publication
(10) Pub. No.: US 2022/0310129 A1
(43) Pub. Date: Sep. 29, 2022

(54) METHOD FOR INDICATING INTEREST POINTS IN A MEDIA PLAYER

(71) Applicant: OZYEGIN UNIVERSITESI, Istanbul (TR)

(72) Inventor: Ali Cengiz BEGEN, Konya (TR)

(73) Assignee: OZYEGIN UNIVERSITESI, Istanbul (TR)

(21) Appl. No.: 17/638,864

(22) PCT Filed: Aug. 28, 2019
(86) PCT No.: PCT/TR2019/050710

§ 371 Date: Feb. 28, 2022

(51) Int. Cl. G11B 27/34; H04N 21/472; H04N 21/258

(52) U.S. Cl. CPC G11B 27/34; H04N 21/47217; H04N 21/25891

(57) ABSTRACT

A method providing an enhanced non-linear viewing/listening experience to users by progressively generating and indicating interest points on a media player is provided. The method includes monitoring interactions of viewers/listeners with the media player comprising at least one of play, stop, rewind, forward, pause, skip, slow or fast motion, zoom in, zoom out, full screen, normal screen, mute, volume up/down actions and a position of a pointer of a seek bar of the media player or a time of a media where an action occurs; multiplying each monitored interaction of the viewers/listeners with a dedicated coefficient of each monitored interaction to get weighted actions; recording each weighted action with a corresponding position of the pointer or the time of the media; and summing up recorded weighted actions of each viewer/listener at a position of the pointer or the time of the media.

### CROSS REFERENCE TO THE RELATED APPLICATIONS

This application is the national stage entry of International Application No. PCT/TR2019/050710, filed on Aug. 28, 2019, the entire contents of which are incorporated herein by reference.

### TECHNICAL FIELD

The present invention relates to a method for indicating interest points in a media player, specifically the interest points being determined based on the interactions of viewers with the media player.

### BACKGROUND

The nature of online media consumption (i.e., viewing/listening) is changing due to the huge volumes of content being produced including content generated by amateur videographers. The type of media content being produced is not only just for entertainment purposes (movies/TV), but can also be instructional and directive (classroom, user generated content, adult content) videos, audios. This leads to a type of viewing/listening that is non-linear and requires increased random access into the content to be consumed effectively.

Today, almost all media players have a seek bar (aka scrub bar or scrubber) that allows the viewer to go forward or backward in the media timeline to consume a desired portion of the media. Moreover, some media players allow the viewers to switch to a desired portion of the indexed media from several desired portions via a set of index points such as thumbnail images often generated automatically from the content. However, which portions of a media will be more popular or of interest than others may not be always anticipated beforehand, and further, such popular portions of the media may change over time. Thus, static interest points generated by the content owner may not always be of interest to the viewers. We see that non-linear viewing behavior is becoming increasingly important and the question of indicating time-varying points of interest is not effectively addressed in the background of the art.

Therefore, there is a need for a method providing enhanced non-linear viewing/listening experience to users by progressively generating interest points through a media player.

### BRIEF DESCRIPTION OF THE DRAWINGS

An exemplary embodiment of the present invention is illustrated by way of example in the accompanying drawings to be more easily understood and uses thereof will be clearer when considered in view of the detailed description, in which like reference numbers indicate the same or similar elements, and the following figures in which:

FIG. 1 is a view of a seek bar showing interest points, interest rate indication and event category indications where the event category indications are content (soccer in this case) related figures in one exemplary embodiment of the present invention.

FIG. 2 is a view of a seek bar showing interest points, interest rate indication and event category indications where the event category indications are content related figures in another exemplary embodiment of the present invention.

The elements illustrated in the figures are numbered as follows:
1. Seek bar
2. Interest point
3. Interest rate indication
4. Event category indication
5. Pointer

### DETAILED DESCRIPTION OF THE EMBODIMENTS

Embodiments of the present invention relate to a method, which may be a computer implemented method, for progressively generating and indicating interest points (2) in a media player. The media player may comprise, but not limited to, for example, a player provided by an operating system, web browser or application. The method comprises monitoring interactions of viewers/listeners with the media player comprising at least one of play, stop, rewind, forward, pause, skip, slow or fast motion, zoom in, zoom out, full screen, normal screen (exiting from full screen), mute, volume up/down actions and monitoring a position of a pointer (5) of a seek bar (1) of the media player or time of a media which is playing on the media player (such as video or audio) where the action occurs. Then, each monitored action is multiplied with a selected coefficient dedicated to each monitored action to get a weighted action.

The weighted actions provide information for interest rate of the viewers/listeners for the corresponding media part. For instance, for a video media if a user full screened the media at a position of the pointer (5) or a time of the media, it is likely that the scene at the position of the pointer (5) or the time of the media is more relevant and important to the viewer. Thus, selected coefficient for this action should be positive. On the contrary, if the user switched from a full screen to a normal screen or skipped the media at a position of the pointer (5) or a time of the media, it is likely that the scene at the position of the pointer (5) or the time of the media is less relevant and important to the viewer. Thus, selected coefficient for this action (normal screening/skipping) should be negative or neutral.

Afterwards in the method, each weighted action with corresponding position of the pointer (5) or time of the media is recorded. Recorded weighted actions at a position of the pointer (5) or a time of the media are summed up. Then, if a total weighted action exceeds at least one selected threshold for a position of the pointer (5) or a time of the media, an interest point (2) is indicated to location on the seek bar (1) which is the position of the pointer (5) or the time of the media.

An exemplary embodiment of the present invention are described below:

Interactions of viewers/listeners with the media player such as play, stop, rewind, forward, pause, skip, slow or fast motion, zoom in, zoom out, full screen, normal screen (exiting from full screen), mute, volume up/down actions are monitored. In addition to this, a position of a pointer (5) where the action occurs on a seek bar (1) of the media player or alternatively, time of a media which is playing on the media player (such as video or audio) is also monitored. When an action occurs, the action is multiplied by a selected coefficient which is dedicated to the action to get a weighted action for the position of the pointer (5) or time of the media. Each weighted action with corresponding position of the pointer (5) or time of the media is recorded. Recorded weighted actions at a position of the pointer (5) or a time of the media are summed up. If a total weighted action exceeds at least one selected threshold for a position of the pointer (5) or a time of the media, an interest point (2) is indicated to a location on the seek bar (1) which is the position of the pointer (5) or (representing) the time of the media. For example, when a viewer pause the media player at time 01:20, 3 points which is the selected coefficient (and also the weighted action) dedicated to the pause action recorded for the time 01:20. Then, when the same or another viewer did another action such as skipping the scene from the time 01:20, −2 points which is the selected coefficient (and also the weighted action) dedicated to the skip is recorded for the time 01:20. After each monitored action, the weighted actions are summed up. In this case, the total weighted actions is [3]+[−2]=1. Then, when the same or another viewer did another action such rewind to the time 01:20, 5 points which is the selected coefficient (and also the weighted action) dedicated to the rewind is recorded for the time 01:20. The total weighted actions is [3]+[−2]+[5]=6. Each action in each time of the media is continuously monitored and their weighted actions are recorded and summed. If the total weighted actions exceed the selected threshold, in this case let say 300, an interest point (2) is indicated to a location on the seek bar (1). The location represents the position of the pointer (5) or time of the media. In this case, if the total weighted actions exceed the selected threshold (300), an interest point (2) is indicated to time 01:20. Interest point (2) may be a navigating tool for the seek bar (1) of the media player. For instance, viewers/listeners easily navigate the media player to go to time of the media such as time 01:20 by clicking the interest point (2).

In another embodiment of the invention, if a total weighted action exceeds different selected thresholds, a different interest rate indication (3) is indicated to the interest points (2) for each different selected threshold. In a variation of this embodiment, the interest rate indication (3) is depicted as a color indication.

In one embodiment of the invention, the number of interest points (2) to be indicated is limited to a maximum number. This way, a simple seek bar (1) interface is formed which provides viewers/listeners to easily navigate among the interest points (2). For this embodiment, if the maximum number of indicated interest points (2) is achieved and if a new selected threshold, which is higher than the lowest selected threshold for previously indicated interest points (2) is exceeded, an indicated interest point (2) for the lowest exceeded threshold is deleted and a new interest point (2) for the new higher selected threshold is indicated. For example, selected thresholds are A<B<C<D<E<F . . . and total interest point (2) number is limited to 5. Interest points (2) are indicated to locations for thresholds A, B, C, C, D (maximum number of indicated interest points (2) which is 5 is achieved). If any new total weighted action exceeds threshold B, the interest point (2) for the exceeded threshold A is deleted and a new interest point (2) which exceeds selected threshold B is indicated to the seek bar (1). Thus, interest points (2) are updated (B, B, C, C, D) progressively based on interest rate (the interactions of the viewers/listeners with the media player).

In another embodiment of the invention, the method comprises determining intervals for selected events on a media by using image processing or machine learning. Then, the method monitors interactions of viewers/listeners with a media player comprising at least one of play, stop, rewind, forward, pause, skip, slow or fast motion, zoom in, zoom out, full screen, normal screen (exiting from full screen), mute, volume up/down actions inside each interval. Later, each monitored action is multiplied with a selected coefficient to get a weighted action.

The weighted actions provide information for interest rate of the viewers/listeners on corresponding intervals. For instance, for a video media if a user full screened the media inside an interval, it is clear that the scene at the interval is more relevant and important to the viewer. Thus, selected coefficient for this action should be positive. On the contrary, if the user switched from a full screen to a normal screen or skipped the media inside an interval, it is also clear that the scene at this interval is less relevant and important to the viewer. Thus, the selected coefficient for this action (normal screening/skipping) should be negative or neutral.

Afterwards in the method, each weighted action is recorded. Recorded weighted actions inside each interval are summed up. Then, an interest point (2) is indicated to locations on a seek bar (1) of the media player where each determined interval begins. Later, if a total weighted action for an interval exceeds at least one selected threshold, an interest rate indication (3) to the interest points (2) is indicated.

The pointer (5) is an indicator that shows current the duration of a media on a seek bar (1). The media may be a streamable media and the media player may be able to play streamable medias.

In another embodiment of the invention, if a total weighted action exceeds different selected thresholds, a different interest rate indication (3) is indicated to the interest points (2) for each different selected threshold. In a variation of this embodiment, the interest rate indication (3) is depicted as a color indication. For example, the interest rate indication (3) having the highest rate is depicted in deep red and the interest rate indication (3) having the lowest rate is depicted in light yellow.

In another embodiment of the invention, an event category indication (4) is indicated to the interest points (2). In a variation of this embodiment, the event category indication (4) is a content related figure, icon or image.

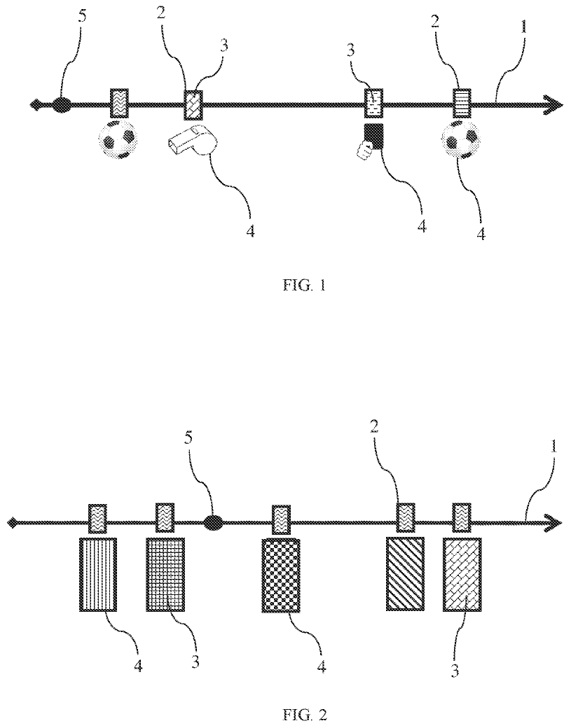

The selected events may be based on content of the media. For example, for a media related to a broadcast of Olympic Games, selected event may be a branch of sports such as football, boxing, cycling. Each interval may be related to a different branch. In another example, for a media related to an animal documentary, selected event may be species. Each interval may be related to a different species. In another example, for a media related to football match, selected event may be an important intervention such as time of goals, penalties, yellow and red cards, substituted players, offsides, fouls, etc. Each interval may be related to a different important intervention. In one exemplary embodiment of the present invention illustrated in FIG. 1, interest points (2) indicated to locations on a seek bar (1) of the media player where each important intervention (determined intervals) begins. Each interest point (2) has an interest rate indication (3) depicted in a different color inside the interest points (2). Each interest point (2) also has an event category indication (4) depicted as content related figures such as soccer ball for goals, card symbols for red or yellow cards, and whistle for fouls.

In another embodiment of the invention, at least one button is provided on the media player interface. Thus, the viewer/listener easily navigates through interest points (2) such as skipping among the interest points (2).

In another embodiment of the invention, at least one filter is provided to the media player for choosing the selected events.

What is claimed is:

1. A method for progressively generating and indicating interest points to a media player, comprising the following steps of:
monitoring interactions of viewers/listeners with the media player comprising at least one of play, stop, rewind, forward, pause, skip, slow or fast motion, zoom in, zoom out, full screen, normal screen, mute, volume up/down actions and a position of a pointer of a seek bar of the media player or a time of a media where an action occurs;
wherein the method further comprising:
multiplying each monitored interaction of the viewers/listeners with a dedicated coefficient of each monitored interaction to get weighted actions;
recording each weighted action with a corresponding position of the pointer or the time of the media;
summing up recorded weighted actions of each viewer/listener at the position of the pointer or the time of the media;
when a total sum of the recorded weighted actions of the viewers/listeners exceeds at least one selected threshold for the position of the pointer or the time of the media, indicating an interest point to a location on the seek bar, wherein the location is the position of the pointer or the time of the media.

2. The method according to claim 1, wherein a number of the interest points to be indicated is limited to a maximum number and wherein when the maximum number of indicated interest point number is achieved and when a new selected threshold higher than a lowest selected threshold for previously indicated interest point is exceeded, an inserted indicated point for a lowest exceeded threshold is deleted and a new interest point for the new selected threshold is indicated.

3. The method according to claim 1, further comprising;
determining intervals to the viewer/listener for selected events on the media by using an image processing and/or a machine learning;
monitoring the interactions of the viewers/listeners with the media player comprising at least one of play, stop, rewind, forward, pause, skip, playing in slow or fast motion, zoom in, zoom out, full screen, normal screen, mute, volume up, volume down actions inside each interval;
multiplying each monitored interaction with a selected coefficient to get the weighted actions;
recording each weighted action;
summing up recorded weighted actions inside each interval; and
indicating the interest point to locations on the seek bar of the media player where each determined interval begins and when a total weighted action for an interval exceeds at least one selected threshold, indicating an interest rate indication to the interest point.

4. The method according to claim 3, further comprising
when the total weighted action exceeds different selected thresholds, indicating a different interest rate indication to the interest point for each different selected threshold.

5. The method according to claim 4, wherein the interest rate indication is depicted as a color indication.

6. The method according to claim 3, further comprising indicating an event category indication to the interest point.

7. The method according to claim 6, wherein the event category indication is a content related figure, an icon or an image.

8. The method according to claim 1, further comprising providing at least one button on a media player interface to navigate through the interest point.

9. (canceled)

10. The method according to claim 2, further comprising;
determining intervals to the viewer/listener for selected events on the media by using an image processing and/or a machine learning;
monitoring the interactions of the viewers/listeners with the media player comprising at least one of play, stop, rewind, forward, pause, skip, playing in slow or fast motion, zoom in, zoom out, full screen, normal screen, mute, volume up, volume down actions inside each interval;
multiplying each monitored interaction with a selected coefficient to get the weighted actions;
recording each weighted action;
summing up recorded weighted actions inside each interval; and
indicating the interest point to locations on the seek bar of the media player where each determined interval begins and when a total weighted action for an interval exceeds at least one selected threshold, indicating an interest rate indication to the interest point.

11. The method according to claim 3, wherein the interest rate indication is depicted as a color indication.

12. The method according to claim 4, further comprising indicating an event category indication to the interest point.

13. The method according to claim 5, further comprising indicating an event category indication to the interest point.

14. The method according to claim 2, further comprising providing at least one button on a media player interface to navigate through the interest point.

15. The method according to claim 3, further comprising providing at least one button on a media player interface to navigate through the interest point.

16. The method according to claim 4, further comprising providing at least one button on a media player interface to navigate through the interest point.

17. The method according to claim 5, further comprising providing at least one button on a media player interface to navigate through the interest point.

18. The method according to claim 6, further comprising providing at least one button on a media player interface to navigate through the interest point.

19. The method according to claim 7, further comprising providing at least one button on a media player interface to navigate through the interest point.
